(19) United States
(12) Patent Application Publication
(10) Pub. No.: US 2020/0260760 A1
(43) Pub. Date: Aug. 20, 2020

(54) FERMENTED PLANT COMPOSITIONS HAVING MODIFIED ORGANOLEPTIC PROPERTIES

(71) Applicant: KEFIPLANT INC., Drummondville (CA)

(72) Inventors: Chantale HOULE, Drummondville (CA); Juliana Miguel VAZ, Quebec (CA)

(21) Appl. No.: 16/795,854

(22) Filed: Feb. 20, 2020

Related U.S. Application Data
(60) Provisional application No. 62/807,940, filed on Feb. 20, 2019.

(51) Int. Cl. A23L 2/38; A23L 33/105; A23L 33/125; A23L 2/60

(52) U.S. Cl. CPC A23L 2/382; A23L 2/60; A23L 33/125; A23L 33/105

(57) ABSTRACT

The present disclosure provides a fermented plant composition comprising (i) at least one component of an aqueous extract of a plant and (ii) at least one organic acid of a fermentation of the aqueous extract of the plant by a consortium of a symbiotic culture of bacteria and yeasts, wherein the aqueous extract of the has an organoleptic defect prior to the fermentation. The resulting fermented plant composition lacks the organoleptic defect of the unfermented plant and, in some embodiments, has an increased bioavailability in one or more components of the composition (when compared to the non-fermented, raw, aqueous plant extract).

### CROSS-REFERENCE TO RELATED APPLICATION

This present application claims priority from U.S. provisional patent application 62/807,940 filed on Feb. 20, 2019 and herewith incorporated in its entirety.

### TECHNOLOGICAL FIELD

The present disclosure relates to compositions obtained from fermenting a plant extract with a symbiotic consortium of bacteria and yeasts.

### BACKGROUND

The challenge of producing food and beverages acceptable to a broad range of consumers involves balancing the flavor, aroma, appearance and satisfying mouthfeel.

Some plant extracts, while containing interesting nutritional and/or functional elements, have an organoleptic defect which prevents their uses at a high concentration in food or beverages.

Stevia (Stevia sp.) is a branched shrub of the Asteraceae family, originating from northeast of Paraguay and south of Brazil. Dried leaves of Stevia are commonly used with the sweet taste that is about 300 times sweeter than regular sucrose with the reduced caloric value due to the presence mainly of two terpene glycosides, rebaudioside A and stevioside. Despite Stevia's sweetening properties, it is also known for its undesirable metallic aftertaste.

Monk fruit, called too Luo Han Guo, is a fruit produced by the plant Siraitia sp., found in southern China. This fruit has intense sweetness due to the presence of terpene glycosides (mogroside IV, mogroside V, mogrol, 11-oxo-mogrol, 11-oxo-mogroside V, and siaminoside-1) which can provide sweetness with negligible calories. However, this plant also has an earthy-burnt, beany, vegetable flavor, sometimes with a bitter taste too.

Guarana (Paullinia sp.) is a plant found in the Amazon region. It is valuated mainly for its stimulant and antioxidant properties because of its high content of caffeine (and in smaller proportions catechin, epicatechin) with a bitter taste, a little earthy-woody.

Cannabis (Cannabis sp.) most likely originates from Central and South Asia. This plant presents a complex composition constituted by cannabinoids, which are known to possess important pharmacological properties. However, this plant and its derivatives present an odor characteristic and a remarkable bitter taste, possibly caused by its terpenoids.

It would be highly desirable to be provided with plant extracts which have a reduction in the organoleptic defect while at the same time includes their nutritional and/or functional elements. In some additional or alternative embodiments, it would be desirable to further increase the bioavailability of the elements of the plants extracts.

### BRIEF SUMMARY

The present disclosure provides a fermented plant composition having improved organoleptic properties with respect to a corresponding unfermented plant composition. The plant composition is fermented with a consortium of a symbiotic culture of bacteria and yeasts and includes an organic acid generated during the fermentation. The fermented plant composition is soluble in an aqueous solution.

In a first aspect, the present disclosure provides a fermented plant composition comprising (i) at least one component of an aqueous extract of a plant and (ii) at least one organic acid of a fermentation of the aqueous extract of the plant by a consortium of a symbiotic culture of bacteria and yeasts, wherein the aqueous plant extract has an organoleptic defect prior to the fermentation. In an embodiment, the organic acid comprises acetic acid, butyric acid, glucoronic acid, gluconic acid, citric acid, L-lactic acid, malic acid, tartaric acid, malonic acid, oxalic acid, succinic acid, pyruvic acid, mannonic acid, propionic acid, ascorbic acid and/or usnic acid. In another embodiment, the plant is from Stevia sp. In such embodiment, the fermented plant composition comprises at least 15% more of rebaudioside A than the aqueous extract of the plant and/or at least 15% less of stevioside than the aqueous extract of the plant. In another embodiment, the plant is from Siraitia sp. In such embodiment, the fermented plant composition can comprise at least 15% more of mogroside IV, mogroside V, mogrol, 11-oxo-mogrol, 11-oxo-mogroside V and/or siaminoside-1 than the aqueous extract of the plant. In another embodiment, the plant is from Paullinia sp. In such embodiment, the fermented plant composition can comprise at least 10% more caffeine than the aqueous extract of the plant. In another embodiment, the fermented plant composition comprises one or more of the following fermentation products of the symbiotic consortium: alcohol, amino acids and/or biocides. In still another embodiment, the fermented plant composition has an increased bioavailability, when compared to the aqueous plant extract, in at least one vitamin, mineral or antioxidant molecule. In a further embodiment, the fermented plant composition is obtained by a process comprising: (a) providing the aqueous extract from the plant; (b) adding a carbohydrate source to the aqueous extract of the plant to obtain a supplemented aqueous plant extract; and (c) fermenting the supplemented aqueous plant extract to with the consortium of a symbiotic culture of bacteria and yeasts under conditions to allow the production of the organic acid by the bacteria of the consortium in the fermented plant composition. In such embodiment, the carbohydrate source can be metabolized by the yeasts of the symbiotic consortium. In yet another embodiment, the process further comprises, prior to step (a), performing an aqueous extraction of the plant. In yet another embodiment, the consortium is or is derived from a kefir grain, water kefir and/or a kombucha culture. In another embodiment, the process further comprises, after step (c), removing or inactivating the consortium. In a specific embodiment, the process comprises filtering the fermented product and/or sterilizing (e.g., pasteurizing) the fermented plant composition. In another embodiment, the process comprises maintaining the relative concentration of the components after step (c). In still another embodiment, the fermented plant composition is a liquid.

According to a second aspect, the present disclosure provides a process for obtaining a fermented plant composition, the process comprising: (a) providing an aqueous extract from a plant; (b) adding a carbohydrate source to the aqueous extract of the plant to obtain a supplemented aqueous plant extract; and (c) fermenting the supplemented aqueous plant extract to with a consortium of a symbiotic culture of bacteria and yeasts under conditions to allow the production of an organic acid by the bacteria of the consortium in the fermented plant composition. In the process, the aqueous plant extract has an organoleptic defect prior to fermentation, and the carbohydrate source can be metabolized by the yeasts of the consortium. In an embodiment, the plant is from Stevia sp. In another embodiment, the process further comprises, prior to step (a), performing an aqueous extraction of the plant. In an embodiment, the organic acid comprises acetic acid, butyric acid, glucoronic acid, gluconic acid, citric acid, L-lactic acid, malic acid, tartaric acid, malonic acid, oxalic acid, succinic acid, pyruvic acid, mannonic acid, propionic acid, ascorbic acid and/or usnic acid. In yet a further embodiment, the consortium is from a kefir grain, a water kefir and/or a kombucha consortium. In still another embodiment, the process further comprises, after step (c), removing or inactivating the consortium. In a specific embodiment, the process comprises filtering the fermented product and/or sterilizing (e.g., pasteurizing) the fermented plant composition. In yet a further embodiments, the process maintains the relative concentration of the components after step (c).

In a third aspect, the present disclosure provides a beverage or a food comprising the fermented plant composition described herein or made by the process described herein.

### BRIEF DESCRIPTION OF THE DRAWINGS

Having thus generally described the nature of the invention, reference will now be made to the accompanying drawings, showing by way of illustration, a preferred embodiment thereof, and in which:

FIGS. 1A to 1E provide chromatograms from high performance liquid chromatography and fermentation profile in accordance with an embodiment of the present disclosure for Stevia. (FIG. 1A) provides the fermentation profile of the unfermented (control or raw, grey bars) material and the fermented material at the end of the fermentation (fermented product, black bars). Results are provided as the mean area under the curve (mAU) in function of retention time and material used. $ indicates the peak associated with rebaudioside A, whereas $$ indicated the peak associated with stevioside. (FIG. 1B) provides a representative chromatogram for the fermentation profile of the unfermented (control or raw) material. Results are provided as the area under the curve (mAU) in function of the retention time. (FIG. 1C) provides the fermentation profile of the unfermented (control or raw) material. Results are provided as the mean area under the curve (mAU) in function of retention time and material used. (FIG. 1D) provides a representative chromatogram for fermented material at the end of the fermentation (fermented product). Results are provided as the area under the curve (mAU) in function of the retention time. (FIG. 1E) provides the fermented material at the end of the fermentation (fermented product). Results are provided as the mean area under the curve (mAU) in function of retention time and material used.

FIGS. 2A to 2E provide chromatograms from high performance liquid chromatography and fermentation profile in accordance with an embodiment of the present disclosure for monk fruit. (FIG. 2A) provides the fermentation profile of the unfermented (control or raw, grey bars) material and the fermented material at the end of the fermentation (fermented product, black bars). Results are provided as the mean area under the curve (mAU) in function of retention time and material used. +, ++ and, +++ indicates the peaks associated with mogroside V, mogroside IV, respectively, whereas +++ indicated the peak associated with siaminoside-1. (FIG. 2B) provides a representative chromatogram for the fermentation profile of the unfermented (control or raw) material. Results are provided as the area under the curve (mAU) in function of the retention time. (FIG. 2C) provides the fermentation profile of the unfermented (control or raw) material. Results are provided as the mean area under the curve (mAU) in function of retention time and material used. (FIG. 2D) provides a representative chromatogram for fermented material at the end of the fermentation (fermented product). Results are provided as the area under the curve (mAU) in function of the retention time. (FIG. 2E) provides the fermented material at the end of the fermentation (fermented product). Results are provided as the mean area under the curve (mAU) in function of retention time and material used.

FIGS. 3A to 3E provide chromatograms from high performance liquid chromatography and fermentation profile in accordance with an embodiment of the present disclosure for guarana. (FIG. 3A) provides the fermentation profile of the unfermented (control or raw, grey bars) material and the fermented material at the end of the fermentation (fermented product, black bars). Results are provided as the mean area under the curve (mAU) in function of retention time and material used. * indicates the peak associated with catechin, whereas ** indicated the peak associated with caffeine, and *** indicated the peak associated with epigallocatechin-3-gallate. (FIG. 3B) provides a representative chromatogram for the fermentation profile of the unfermented (control or raw) material. Results are provided as the area under the curve (mAU) in function of the retention time. (FIG. 3C) provides the fermentation profile of the unfermented (control or raw) material. Results are provided as the mean area under the curve (mAU) in function of retention time and material used. (FIG. 3D) provides a representative chromatogram for fermented material at the end of the fermentation (fermented product). Results are provided as the area under the curve (mAU) in function of the retention time. (FIG. 3E) provides the fermented material at the end of the fermentation (fermented product). Results are provided as the mean area under the curve (mAU) in function of retention time and material used.

### DETAILED DESCRIPTION

The present disclosure provides a fermented plant composition comprising at least one component of an extract of a plant (e.g. plant extract) and at least one additional components (e.g. an organic acid such as, for example, acetic acid) which is obtained by fermenting the plant extract with bacteria and yeasts (which can, in an embodiment, be a consortium of symbiotic bacteria and yeasts). The fermented plant composition is soluble in an aqueous solution (such as water). In an embodiment, the extract of the plant can have a sweet taste and a low calorie content. In the context of the present disclosure, the plant extract can have, prior to fermentation, an organoleptic defect which is reduces or absent in the fermented plant composition. The organoleptic defect is an unpleasant sensory sensation associated with the smell or the taste of a food or a beverage. Depending on the context, includes, but is not limited to dandelion type (ammonia odor), garlic type (sulphurous odor), rancid type (due to decomposition of oils and fats), valerian type (age developed), bitter almond type (aromatic, somewhat pleasant, marzipan-like), patchouli type (musk-like, heavy, disagreeable to many), seaweed type (briny odor), soil type (earthy, faintly musty odor) and/or metallic type. In an embodiment, the organoleptic defect, when the plant is Stevia sp., Siraitia sp. or Paullinia sp. is a mixture of earthy, bitter and metallic types.

Without wishing to be bound to theory, the plant and its resulting plant extract include one or more plant components (such as glycosides for example) which is responsible, at least in part, for the organoleptic defect. The symbiotic consortium of bacteria and yeasts is responsible for removing a carbohydrate moiety from one or more plant component and replacing it by an hydroxyl group. This biological de-glycosylation step can lead to the reduction in the organoleptic defect and/or to an increase in bioavailability of the de-glycosylated plant component (when compared to the original plant component). In some embodiments, the symbiotic consortium of bacteria and yeasts modifies the glycosylation pattern of one or more component of the plant or the plant extract. It is contemplated herein that additional components of the aqueous plant extract can be modified by the consortium during fermentation.

### Fermented Plant Compositions

The present disclosure provides a fermented plant composition obtained from fermenting an extract of a plant with a consortium of symbiotic bacteria and yeasts. The fermented plant composition can be derived from any extract of any plant exhibiting an organoleptic defect. The extract can be made with the plant or parts thereof (seed, flower (including flower bud), fruit, leave, bark, root, etc.). The plant from which an extract is made can be, without limitation, from Stevia sp. (Stevia rebaudiana or Stevia phlebophylla), Paullinia sp. (e.g., guarana such as Paullinia cupana, Paullinia crysan or Paullinia sorbilis), Siraitia sp. (e.g., monk fruit Siraitia grosvenorii), Cannabis sp. (e.g., Cannabis sativa, Cannabis indica or Cannabis ruderalis) Cascara sp. (Rhamnus purshiana or Frangula purshiana), flex sp. (e.g., yerba mate such as Ilex paraguariensis), Rosaceae sp. (e.g., agrimony), Medicago sp. (e.g., alfalfa or Medicago sativa), Pimpinella sp. (e.g., anise or Pimpinella anisumn) Bixa sp. (e.g., annatto or Bixa orellana), Cyrana sp. (e.g., artichoke or Cyrana cardunculus), Withania sp. (e.g., ashwagandha or Withania somnifera), Astralagus sp., Ocimum sp. (e.g., basil or Ocimum basilicum), Betula sp. (e.g., birch), Piper sp. (e.g., black pepper or Piper nigrum; kava kava or Piper methysticum), Rubus sp. (e.g., blackberry), Artium sp. (e.g., burdock), Apium sp. (e.g., celery or Apium graveolens), Asteraceae sp. (e.g., chamomile), Cinnamomum sp. (e.g., cinnamon), Myrtaceae sp. (e.g., clove), Coffea sp. (e.g., coffee or Coffea arabica, Coffea robusta), Coriandrum sp. (e.g., coriander or Coriandrum sativum), Cuminum sp. (e.g., cumin or Cuminum cyminum), Taraxacum sp. (e.g., dandelion or Taraxacum officinale), Desmodium sp., Sambucus sp. (e.g., elder flower). Eucalyptus sp. (e.g., Eucalyptus obliqua), a Euphrasia sp., Foeniculum sp. (e.g., fennel or Foeniculum vulgare), Allium sp. (e.g., garlic or Allium sativum), Zingiber sp. (e.g., ginger or Zingiber officinale), Panax sp. (e.g., ginseng), Camellia sp. (e.g., green tea, matcha tea or Camellia sinensis), Hibiscus sp., Ocimum sp. (e.g., holy basil or Ocimum tenuiflorum), Humulus sp. (e.g., hop or Humulus lupulus), Handroanthus sp. (e.g., lapacho or Handroanthus impetiginosus), Lavandula sp. (e.g., lavender or Lavandula spica), Cymbopogon sp. (e.g., lemongrass or Cymbopogon schenanthus), Lepidium sp. (e.g., maca or Lepidium meyenii), Filipendula sp. (e.g., meadowsweet or Filipendula ulmaria), Silybum sp. (e.g., milk thistle or Silybum marianum), Azadirachta sp. (e.g., neem or Azadirachta indica), Urtica sp. (e.g., nettle), Petroselinum (e.g., parsley or Patroselinum crispum). Passifloroideae sp. (e.g., passion flower), Mentha sp. (e.g., peppermint or Mentha piperita), Musa sp. (e.g., plantain or Musa paradisiaca), Rubus sp. (e.g., raspberry or Rubus ideaobatus), Rhodiola sp., Aspalathus sp. (e.g., rooibos or Aspalathus linearis), Salvia sp. (e.g., rosemary or Salvia rosmarinus; sage or Salvia officinalis), Satureja sp. (e.g., savory), Curcuma sp. (e.g., turmeric or Curcuma longa), Valeriana sp. (e.g., valerian or Valeriana officinalis), Viola sp. (e.g., violet), Triticum (e.g., wheat (including wheatgrass) or Triticum aestivum), Salix sp. (e.g., white willow or Salix alba), Achillea sp. (e.g., yarrow or Achillea millefolium), Melissa sp. (e.g., lemon balm or Melissa officinalis), Tribulus sp. (e.g., puncturevine or Tribulus terrestris), Ginkgo sp., Serenoa sp. (e.g., saw palmetto or Serenoa repens), Hypericum sp. (e.g., Saint-John's wort or Hypericum perforatum), Capsicum sp. (e.g., cayenne or Capsicum frutescens), algae (such as, for example, Arthrospira sp. (e.g., spirulina, Arthrospira platensis or Arthrospira maxima; a kelp), Tanacetum sp. (e.g., feverfew or Tanacetum parthenium), Hordeum sp. (e.g., barley or Hordeum vulgare), Glycyrrhiza sp. (e.g., licorice or Glycyrrhiza glabra) and combinations thereof. In some embodiments, the plant or the resulting plant extract can have a sweet taste (such as for example Stevia sp. and/or Siraitia sp.). In some additional embodiments, the plant or the resulting plant extract has a sweet taste and has a low calorie content and/or low glycemic index (e.g., such as for example Stevia sp. and/or Siraitia sp.). In some further embodiments, the plant or the resulting plant extract has a sweet taste and does not have a carbohydrate source which is fermentable by the yeasts of the symbiotic consortium. The extract can be made from the entire plant or one or more portion of the plant, such as, for example, the leaves, the stem, trunk, the flowers, the fruits, the seeds and/or the roots. In an embodiment, the extract is made from the leaves of the plant (for example when the plant is Stevia sp.). In another embodiment, the extract is made from the seeds of the plant (for example when the plant is Paullinia sp.). In a further embodiment, the extract is made from the fruit of the plant (for example when the plant is Siraitia sp.).

In an embodiment, the extract is an organic extract obtained by an organic solvent. For example, the extract can be obtained from an organic extraction (such as an organic solvent) with the plant or part of a plant. In such embodiment, it may be necessary to further treat the organic extract to remove the organic solvent so as to allow a subsequent fermentation step. In another embodiment, the extract is an aqueous extract obtained from infusing an aqueous solution (such as water) with the plant or part of a plant. Such embodiment may be advantageous as it can be directly submitted to fermentation without prior purification. For example, when the extract is an aqueous extract it can be obtained from infusing an aqueous solution (such as water) with the plant or part of a plant. In another embodiment, the extract is a mixture of components obtained both from an aqueous and an organic extraction.

The plant extract is then submitted to a symbiotic consortium of bacteria and yeasts (e.g., scoby). The consortium includes both bacteria and yeasts and can be presented in a matrix, such as a polysaccharide matrix, made at least in part by the organisms of the consortium. The consortium is considered to be symbiotic because the bacteria and yeasts composing it metabolize their respective metabolic products. For example, in one specific embodiment, the yeasts metabolize a carbohydrate into ethanol and organic acids. In return, the bacteria metabolize/oxidize ethanol into acetaldehyde, and acetaldehyde hydrates into acetic acid.

The consortium can be or be derived from a kefir grain. Kefir grains include both bacteria and yeasts capable of fermenting dairy (“milk kefir” capable of fermenting cow, goat or sheep's milk for example) and non-dairy (“water kefir” capable of fermenting vegetable milk such as soy, almond, cashew, or oatmeal milk and/or fruits (such as coconut, dates, figs, ginger, lemon), vegetables and botanicals for example) solutions. The consortium can be or be derived from a kombucha culture (“tea mushroom”, “tea fungus”, “jun”, “jun tea” or “Manchurian mushroom”) including both bacteria and yeasts and being capable of fermenting tea or a tea infusion.

The fermented plant composition of the present disclosure includes at least one organic acid which is generated from the symbiotic consortium of bacteria and yeasts during the fermenting step. The organic acid can be without limitation acetic acid, butyric acid, glucoronic acid, gluconic acid, citric acid, lactic acid (such as L-lactic acid), malic acid, tartaric acid, malonic acid, oxalic acid, succinic acid, pyruvic acid, mannonic acid, propionic acid, ascorbic acid and/or usnic acid. In some embodiments, the fermented plant composition can include lactic acid, but only in trace amounts. In an embodiment, the organic acid is or comprises acetic acid. In one specific embodiment, the organic acids generated from the consortium are mainly composed of acetic acid. In an embodiment, at least 50, 55, 60, 65, 70, 75, 80% or more of the organic acid generated by the consortium is acetic acid.

The fermented plant composition of the present disclosure can optionally include additional components generated from the symbiotic consortium. The optional components can include, without limitation, alcohol, gas (such as CO₂), amino acids, peptides and/biocides. In an embodiment, once the fermentation is completed, no components (except water) from the plant extract and the components have been metabolized/generated by the consortium are added or removed from the fermented plant composition. In another embodiments, once the fermentation is completed, one or more components from the plant extract and the components have been metabolized/generated by the consortium can be added or removed from the fermented plant composition. For example, one or more components of the fermented plant composition (such as, for example, an organic acid and/or an alcohol) can be removed in part or totally. In yet another example, one or more components of the fermented plant composition can be isolated (such as, for example, an antioxidant compound).

The fermented plant composition of the present disclosure can optionally include additional components from the plant (vitamins, minerals and/or antioxidant molecules). In an embodiment, the fermented plant composition comprises the entirety or the majority of the components of the plant extract which has not been metabolized by the consortium.

In some embodiments, the fermentation by the consortium can increase the bioavailability of one or more components of the plant extract, when compared to an unfermented plant extract.

When the plant is Stevia sp., the plant extract can include steviol glycosides such, as, but not limited to, stevioside, dulcoside A, rebaudioside A, rebaudioside B, rebaudiosaide C, rebaudiose D and/or rebaudioside E. The fermented plant composition made from the Stevia sp. plant can comprise stevioside, dulcoside A, rebaudioside A, rebaudioside B, rebaudiosaide C, rebaudiose D and/or rebaudioside E. In an embodiment, the fermented plant composition comprises at least more than 15%, 20%, 25%, 30%, 35%, 40% or 45% (w/w) rebaudioside A when compared to the plant extract. In another embodiment, the fermented plant composition comprises at least less than 45%, 40%, 35%, 30%, 25%, 20% or 15% (w/w) of stevioside when compared to the unfermented plant extract. In a further embodiment, the fermented plant composition exhibits less of a metallic taste (or even no metallic taste) when compared to the aqueous plant extract. The Stevia plant composition is soluble in an aqueous solution (such as water).

When the plant is Siraitia sp., the unfermented aqueous plant extract can include glycosides such, as, but not limited to, mogroside IV, mogroside V, mogrol, 11-oxo-mogrol, 11-oxo-mogroside V and/or siaminoside-1. The fermented plant composition made from the Siraitia sp. plant can comprise mogroside IV, mogroside V, mogrol, 11-oxo-mogrol, 11-oxo-mogroside V and/or siaminoside-1, albeit in different proportions than the unfermented aqueous plant extract of Siraitia sp. In an embodiment, the fermented plant composition comprises at least more than 15%, 20%, 25%, 30%, 35%, 40% or 45% (w/w) mogroside IV or siaminoside-1 (when compared to the unfermented aqueous plant extract). In still another embodiment, the fermented plant composition comprises at least less than 45%, 40%, 35%, 30%, 25%, 20% or 15% (w/w) of mogroside V (when compared to the unfermented aqueous plant extract). In an embodiment, the fermented plant composition made from Siraitia sp. exhibits less of an earthy/burnt aftertaste than the unfermented aqueous extract of Siraitia sp. The Siraitia plant composition is soluble in an aqueous solution (such as water).

When the plant is Paullinia sp., the unfermented aqueous plant extract can include steviol glycosides such, as, but not limited to, caffeine, catechin and/or epigallocatechin-3-gallate. The fermented plant composition made from the Paullinia sp. plant can comprise caffeine, catechin and/or epigallocatechin-3-gallate. In an embodiment, the fermented plant composition comprises at least more than 10%, 15%, 20%, 25%, 30%, 35% or 40% (w/w) caffeine when compared to the plant extract and/or at least more than 10%, 15%, 20%, 25%, 30%, 35% or 40% (w/w) catechin and epigallocatechin-3-gallate when compared to the unfermented plant extract. In an embodiment, the fermented plant composition made from Paullinia sp. exhibits less of an earthy/bitter aftertaste than the unfermented aqueous extract of Paullinia sp. The Paullinia plant composition is soluble in an aqueous solution (such as water).

When the plant is Cannabis sp. the unfermented aqueous plant extract can include cannabinoids, as, but not limited to, CBD (cannabidiol), CBDA (cannabidiolic acid) and terpenoids, including, but not limited to, limonene, myrcene, and carvacrol. In an embodiment, the fermented plant composition made from Cannabis sp. exhibits less of a bitter aftertaste than the unfermented aqueous extract of Cannabis sp. In a further embodiment, the fermented plant composition comprises less terpenoids (for example less than 10%, 15%, 20%, 25%, 30%, 35% or 40% (w/w)) than the unfermented aqueous extract of Cannabis sp. The Cannabis plant composition is soluble in an aqueous solution (such as water).

### Processes for Making the Fermented Plant Compositions

The process of the present disclosure includes providing a plant extract such as an aqueous extract (referred to as an “aqueous extract” in the present disclosure). In some optional embodiments, the process includes performing the aqueous extraction. The aqueous extracts can prepared under hot or cold conditions by infusion, decoction, percolation or maceration. When the aqueous extract is obtained by an infusion, the process can include infusion between about 10 to 80 g/L of the plant (which can be provided in a dried form) in an aqueous solution (such as water). In an embodiment, the extraction includes adding at least about 10, 15, 20, 25, 30, 35, 40, 45, 50, 55, 60, 65, 70 or 75 g/L of the plant to the aqueous solution. In another embodiment, the extraction includes adding no more than about 80, 75, 70, 65, 60, 55, 50, 45, 40, 35, 30, 25, 20 or 15 g/L or about 80, 75, 70, 65, 60, 55, 50, 45, 40, 35, 30, 25, 20 or 15 g/L of the plant to the aqueous solution. During the extraction step, the aqueous solution can reach a temperature between about 50° C. to about 95° C. In an embodiment, during the extraction step, the aqueous solution reaches a temperature of at least about 50° C., 55° C., 60° C., 65° C., 70° C., 75° C., 80° C., 85° C. or 90° C. In another embodiment, during the extraction step, the aqueous solution reaches a temperature of no more than about 95° C., 90° C., 85° C., 80° C., 75° C., 70° C., 65° C., 60° C. or 55° C. In still another embodiment, during the extraction step, the aqueous solution reaches a temperature of between about 50° C., 55° C., 60° C., 65° C., 70° C., 75° C., 80° C., 85° C. or 90° C. and about 95° C., 90° C., 85° C., 80° C., 75° C., 70° C., 65° C., 60° C. or 55° C. The extraction step can last between about for 20 to about 90 minutes. In an embodiment, the extraction step can last at least about 20, 25, 30, 35, 40, 45, 50, 55, 60, 65, 70, 75, 80 or 85 minutes. In another embodiment, the extraction step can last no more than about 90, 85, 80, 75, 70, 65, 60, 55, 50, 45, 40, 35, 30 or 25 minutes. In still another embodiment, the extraction step lasts between about 20, 25, 30, 35, 40, 45, 50, 55, 60, 65, 70, 75, 80 or 85 and about 90, 85, 80, 75, 70, 65, 60, 55, 50, 45, 40, 35, 30 or 25 minutes. In some embodiments, the aqueous extract may then be filtered to separate the insoluble particles from the soluble particles. In additional embodiments, the aqueous extract may be dried in total or in part prior to the fermentation step. In some alternative embodiments, the aqueous extract may be directly submitted to a fermentation step.

In the process of the present disclosure, the aqueous solution is supplemented with a carbohydrate source which can be used (e.g., metabolized or fermented) by the yeasts of the symbiotic consortium of bacteria and yeasts. Carbohydrate sources which can be used by the yeasts of the consortium include, without limitation, monosaccharides (such as glucose, fructose and/or galactose), disaccharides (such as sucrose and/or maltose) as well as complex mixtures of carbohydrates (molasses and/or honey for example). In additional embodiments, the carbohydrate source is provided at a concentration between about 30 to about 100 g/L in the aqueous extract. In an embodiment, the carbohydrate source is provided at a concentration of at least about 30, 31, 32, 33, 34, 35, 36, 37, 38, 39 40, 41, 42, 43, 44, 45, 46, 47, 48, 49, 50, 51, 52, 53, 54, 55, 56, 57, 58, 59 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98 or 99 g/L in the aqueous extract. In still another embodiment, the carbohydrate source is provided at a concentration of no more than about 100, 99, 98, 97, 96, 95, 94, 93, 92, 921, 90, 89, 88, 87, 86, 85, 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 49, 48, 47, 46, 45, 44 43, 42, 41, 40, 39, 38, 37, 36, 35, 34, 33, 32 or 31 g/L in the aqueous extract. In yet a further embodiment, the carbohydrate source is provided at a concentration between about 30, 31, 32, 33, 34, 35, 36, 37, 38, 39 40, 41, 42, 43, 44, 45, 46, 47, 48, 49, 50, 51, 52, 53, 54, 55, 56, 57, 58, 59 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98 or 99 and about 100, 99, 98, 97, 96, 95, 94, 93, 92, 921, 90, 89, 88, 87, 86, 85, 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 49, 48, 47, 46, 45, 44 43, 42, 41, 40, 39, 38, 37, 36, 35, 34, 33, 32 or 31 g/L in the aqueous extract. The supplementation step can also include stirring the supplemented aqueous plant extract to dissolve the carbohydrate in solution. The supplementation step can include an optional step of cooling the aqueous plant extract (for example at a temperature between about 25° C. and about 29° C.) prior to conducting the fermentation step. In some embodiments, the carbohydrate source is sucrose.

The fermentation step also includes contacting the symbiotic consortium of bacteria and yeasts with the aqueous extract. This can be done before, after or at approximately the same time as the aqueous extract is being supplemented with the carbohydrate source. The amount of consortium to be used will depend on the type of aqueous extract as well as the amount of supplementation.

The fermentation is conducted under conditions so as to allow the metabolism of the plant glycoside by the consortium until the organoleptic defect is reduced or removed from the fermented product. In some embodiments, the fermentation is conducted for a minimum of 20, 30, 40, 50, 60, 70, 80, 90, 100, 110, 120, 130, 140, 150, 160, 170, 180, 190, 200 consecutive days or more.

In some embodiments, the fermentation is a mesophilic fermentation, as the fermentation temperature is below 30° C. and for example can vary between about 20 and 29° C. In an embodiment, the fermentation is conducted at a temperature of at least about 20° C., 21° C., 23° C., 24° C., 25° C., 26° C., 27° C., 28° C. or 29° C. In another embodiment, the fermentation is conducted at a temperature of no more than about 29° C., 28° C., 27° C., 26° C., 25° C., 24° C., 23° C., 22° C. or 21° C. In still another embodiment, the fermentation is conducted at a temperature of between about 20° C., 21° C., 23° C., 24° C., 25° C., 26° C., 27° C., 28° C. or 29° C. and about 29° C., 28° C., 27° C., 26° C., 25° C., 24° C., 23° C., 22° C. or 21° C.

The fermentation may also take place under static conditions, i.e. a static fermentation where no stirring takes place. When the fermentation is a static one, the fermentation medium may be stirred when during sampling.

In some embodiments, the fermentation process is conducted in the absence of exogenous purified enzymes and genetically-modified organisms. In still another embodiment, the process does not include adding a component (besides the carbohydrate supplement and the consortium) to the plant aqueous extract. In still another embodiment, the process does not include removing, once fermentation has begun, a component from the fermentation medium or the fermented plant composition (except water and/or the consortium, in some embodiments). In such embodiments, the process is conducted so as to maintain the relative concentration of the components of the fermented plant composition once fermentation is completed.

The fermentation is considered to be completed when the organoleptic defect of the aqueous plant extract is reduced or removed from the fermented plant composition. Alternatively or in combination, the fermentation can also considered to be completed when the pH of the fermented plant composition reaches 4.0 or less and/or the microorganisms of the consortium are stabilized (e.g., in a stationary phase of the fermentation).

When the fermentation is completed, the process can optionally include a step of removing or inactivating the consortium from the fermented plant composition. For example, the process can optionally include a step of removing the consortium by centrifuging (for example at about 2000-5000 rpm during 10 to 20 minutes), filtering the fermented plant composition (for example by using a filter (plate or cartridge) with pores of 45 μm or 0.2 μm) and/or sterilizing (for example pasteurizing) the fermented plant composition.

The fermented plant composition can be provided in a liquid or solid form. For example, the process can also include freezing and/or drying, at least in part, the fermented plant composition to provide a concentrated liquid and/or a solid (e.g., powder). The optional drying step can be conducted in the presence or absence of a drying support. When provided in a solid and dried form, the fermented plant composition can be sealed in a water-tight container to prevent or limit water uptake during storage.

### Intended Uses of the Fermented Plant Composition

The fermented plant composition can be used to supplement food or beverages or can be directly added in food or beverages. In the embodiments in which the plant and its associated plant extract have a sweet taste, the fermented plant composition is expected to also have a sweet taste and can be used to sweeten food and/or beverages. In some embodiments, the fermented plant extract is the only sweetening agent that is added to the food or beverage. In another embodiment, the fermented plant extract is combined with another sweetening agent in the food or beverage.

The present invention will be more readily understood by referring to the following examples which are given to illustrate the invention rather than to limit its scope.

### Example I—Fermentation of Stevia

The glycoside forms of Stevia compounds were extracted by liquid extraction using water heated at a temperature of 50-95° C. The Stevia extract was supplemented with disaccharide and submitted to a fermentation for 38 days with a consortium of a symbiotic culture of bacteria and yeasts until the stationary phase of the consortium.

The physicochemical properties of fermentation products were compared to the raw material extraction (unfermented). The pH of the products was obtained as a measure of acidity and alkalinity of a solution (pH meter HI 991002). The acidity (g/L) was determined to quantify of the acid content (and especially the acetic acid content) in the fermented products (acid-basic titration and IR measurements—FTNIR Bruker Tango). Organoleptic analyses were performed to evaluate the three taste characteristics of the fermented stevia products: aftertaste, sweetness, and acidity. The results of these physicochemical properties were included in Table 1.

TABLE 1
Characteristics of the fermented Stevia products.

| | Physicochemical | | |
|---|---|---|---|
| | characteristics | | |
| Number of days of the | | Acidity | |
| fermentation | pH | (g/L) | Organoleptic properties |
| Extract/Raw, | 5.82 | 0 | Sweet with an aftertaste |
| unfermented product | | | of licorice, “earthy” |
| (prior to fermentation) | | | |
| 14 | 3.22 | 4.2 | Sweet with an aftertaste |
| | | | of licorice, slightly |
| | | | acidic |
| 28 | 3.27 | 7.8 | Sweet with a slight after- |
| | | | taste of licorice, acidic |
| 38 (fermented product) | 3.25 | 10.2 | Sweet with no aftertaste |
| | | | of licorice, acidic |

As indicated in Table 1, the profile of the components of the product changed during fermentation over time. Brix values decreased, likely indicating the first step of bioconversion by yeasts action. At the same time, pH decreased indicating the increase of the acidity level in the medium, likely caused by bacterial action.

The products obtained prior to, during and after fermentation were analyzed by HPLC analyses using a 1260 Infinity (Agilent Technology), including a quaternary pump, a temperature-controlled column compartment, an auto sampler and, a UV absorbance detector. Acetonitrile in water were used for elution in analyses.

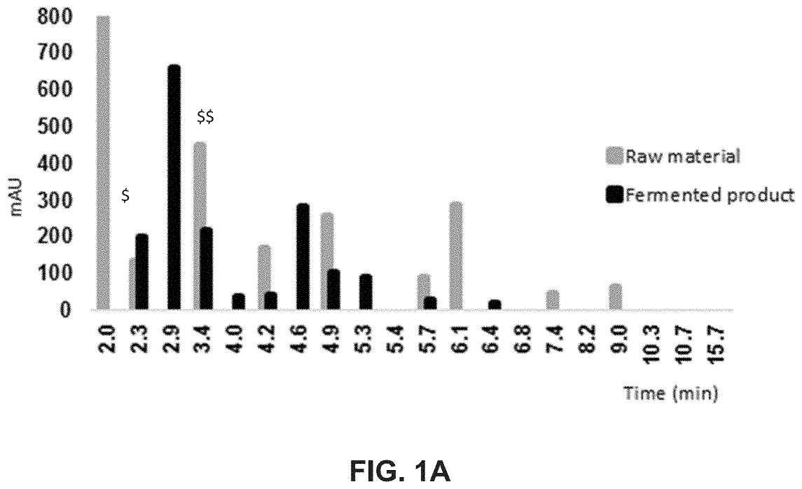

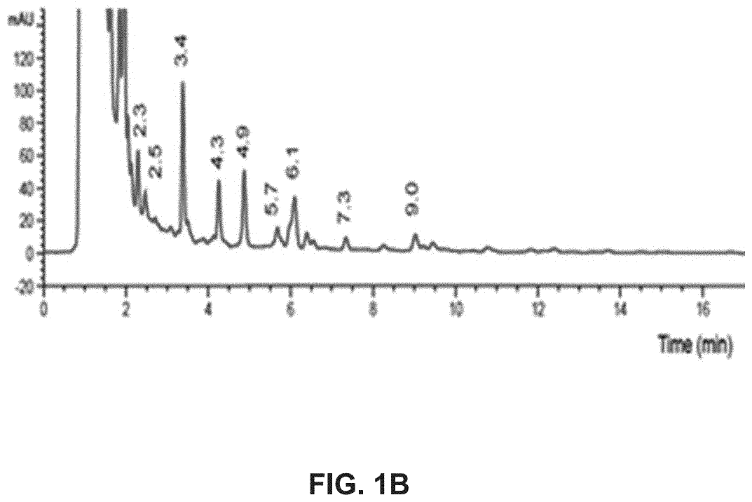

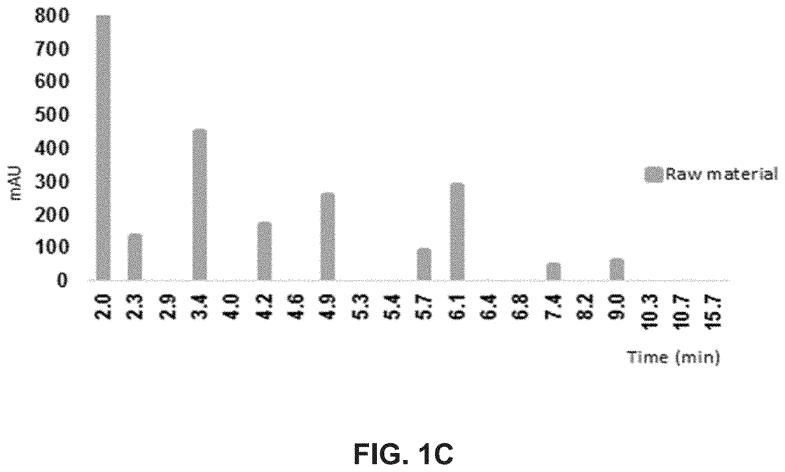

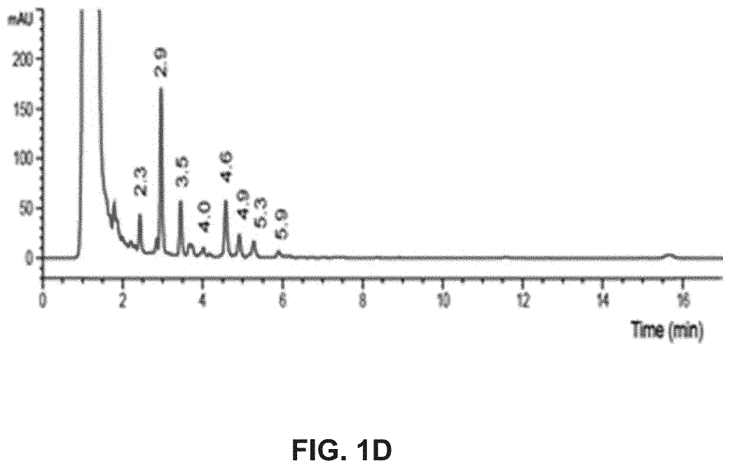

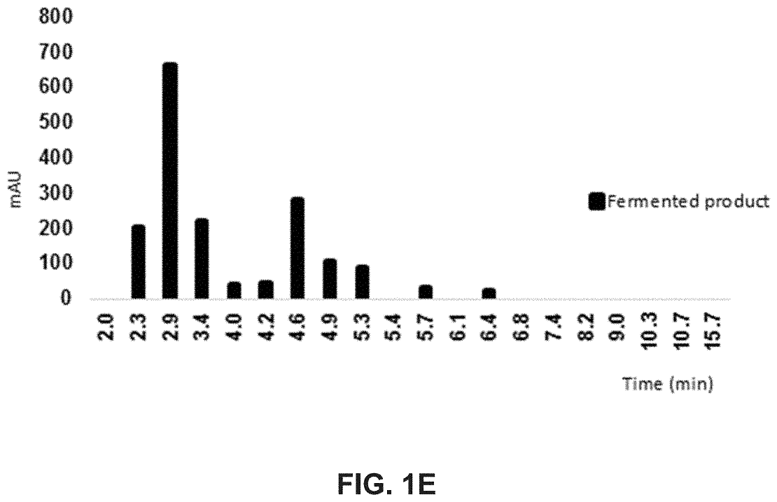

As shown in FIG. 1, HPLC results showed several peaks for stevia raw material (represented by grey bars) which changed in intensity and nature over the fermentation. For example, the concentration of rebaudioside A (which has a retention time of 2.3 min) increased by 47.5% prior (raw material) to and after (fermented product) fermentation (see “$” on FIG. 1A). Also, the concentration of stevioside (with has a retention time of 3.4 min) decreased by about 52% prior (raw material) to and after (fermented product) fermentation (see “$$” on FIG. 1A).

### Example II—Fermentation of Monk Fruit

The glycoside forms of monk fruit compounds were extracted by liquid extraction using water heated at a temperature of 50-95° C. The monk fruit extract was supplemented with disaccharide and submitted to a fermentation for 25 days with a consortium of a symbiotic culture of bacteria and yeasts until the stationary phase of the consortium.

The physicochemical properties of fermentation products were compared to the raw material extraction (unfermented). The pH of the products was obtained as a measure of acidity and alkalinity of a solution (pH meter HI 991002). The acidity (g/L) was determined to quantify of the acid content (and especially the acetic acid content) in the fermented products (acid-basic titration and IR measurements—FTNIR Bruker Tango). Organoleptic analyses were performed to evaluate the three taste characteristics of the fermented stevia products: aftertaste, sweetness, and acidity. The results of these physicochemical properties were included in Table 2.

TABLE 2
Characteristics of the fermented monk fruit products.

| | Physicochemical | | |
|---|---|---|---|
| | characteristics | | |
| Number of days of the | | Acidity | |
| fermentation | pH | (g/L) | Organoleptic properties |
| Extract/Raw, | 4.50 | 0 | Dark brown color; sweet, |
| unfermented product | | | earthy-burnt taste |
| (prior to fermentation) | | | |
| 0 (Raw, unfermented | 4.49 | 0.6 | Dark brown color; earthy- |
| product) | | | burnt taste |
| 14 | 3.25 | 7.4 | Brown color; sweet taste, |
| | | | mild earthy-burnt taste |
| | | | and, little sparkling |
| 20 | 2.93 | 12.0 | Brown color; sweet taste, |
| | | | little sparkling, no |
| | | | earthy-burnt taste |
| 25 (fermented product) | 2.76 | 13.2 | Brown color; sweet, |
| | | | sparkling and acid, no |
| | | | earthy-burnt taste |

As indicated in Table 2, the profile of the components of the product changed during fermentation over time. Brix values decreased, likely indicating the first step of bioconversion by yeasts action. At the same time, pH decreased indicating the increase of the acidity level in the medium, likely caused by bacterial action. Through the two steps of bioconversion, organoleptic properties of fermented product are improved.

The products obtained prior to, during and after fermentation were analyzed by HPLC analyses using a 1260 Infinity (Agilent Technology), including a quaternary pump, a temperature-controlled column compartment, an auto sampler and, a UV absorbance detector. Methanol in water were used for elution in analyses.

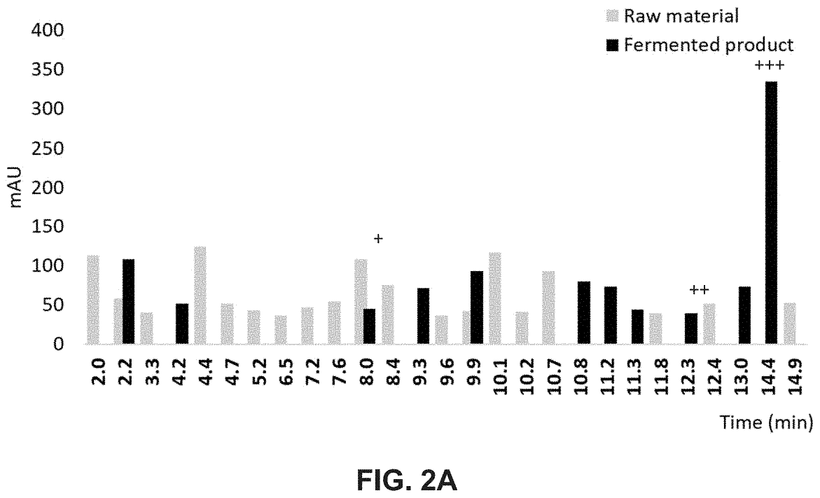

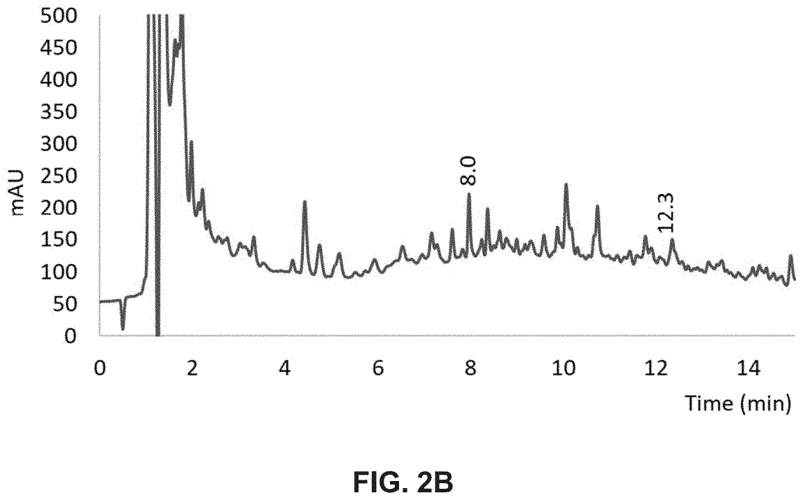

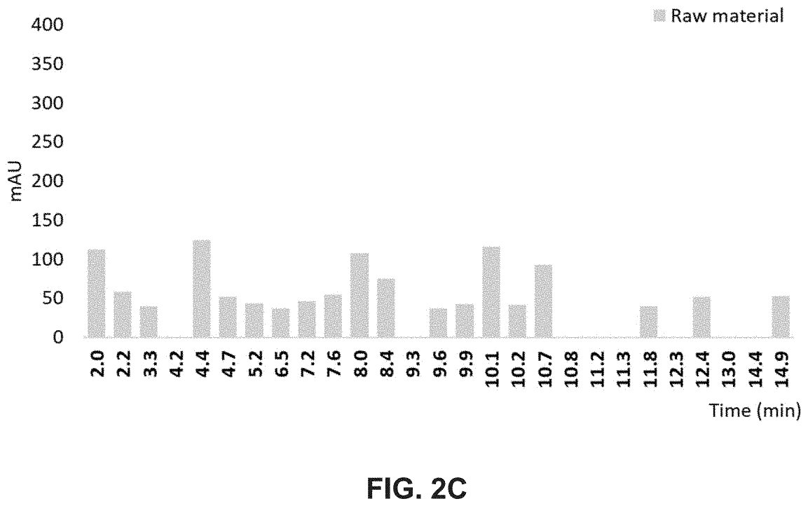

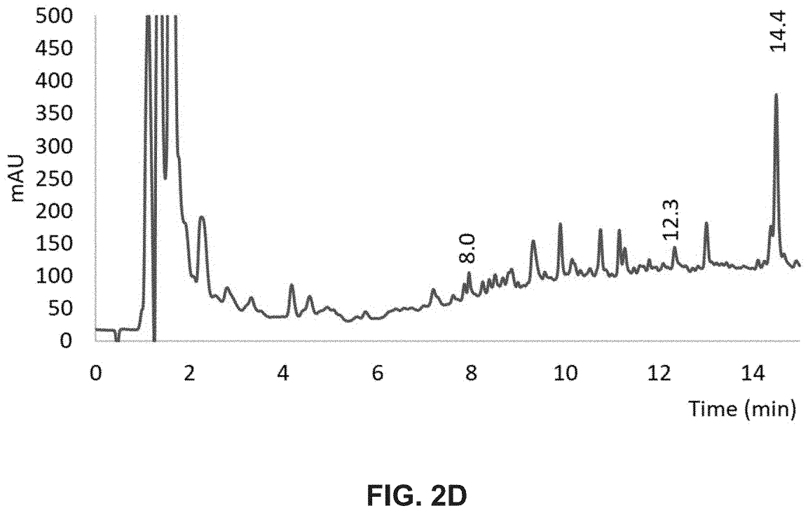

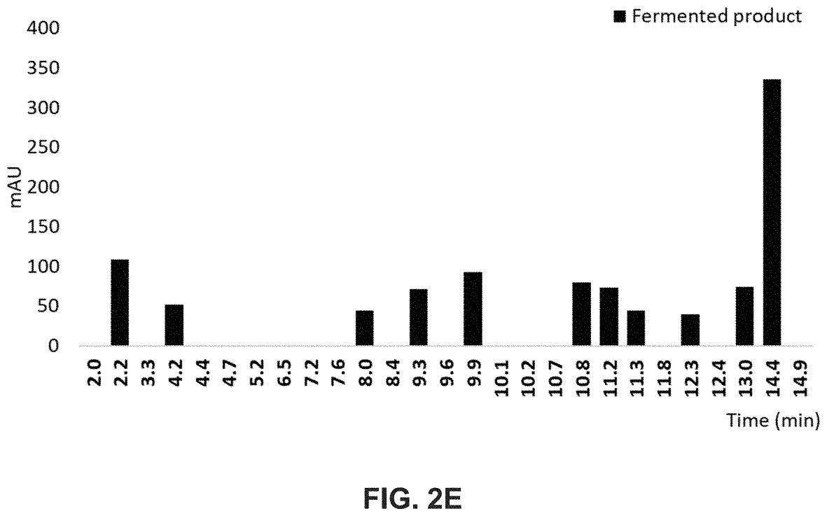

As presented in FIG. 2, HPLC results showed several peaks for monk fruit raw material (represented by grey bars) which changed in intensity and nature over the fermentation. For example, the concentration of mogroside V (indicated by +; retention time of 8.0 min) decreased by 41.4%. Instead, the concentration of mogroside IV (indicated by ++; retention time of 12.3 min) and the concentration of siamenoside-1 (indicated by +++; retention time of 14.4 min) increased by 39.2% and 334.93%, respectively (see in FIG. 2A the changes prior (raw material) to and after (fermented product) fermentation).

### Example III—Fermentation of Guarana

The glycoside forms of guarana compounds were extracted by liquid extraction using water heated at a temperature of 50-95° C. The guarana extract was supplemented with disaccharide and submitted to a fermentation for 31 days with a consortium of a symbiotic culture of bacteria and yeasts until the stationary phase of the consortium.

The physicochemical properties of fermentation products were compared to the raw material extraction (unfermented). The pH of the products was obtained as a measure of acidity and alkalinity of a solution (pH meter HI 991002). The acidity (g/L) was determined to quantify of the acid content (and especially the acetic acid content) in the fermented products (acid-basic titration and IR measurements—FTNIR Bruker Tango). Organoleptic analyses were performed to evaluate the three taste characteristics of the fermented guarana products: aftertaste/bitter, sweetness, and acidity. The results of these physicochemical properties were included in Table 3.

TABLE 3
Characteristics of the fermented Guarana products.

| | Physicochemical | | |
|---|---|---|---|
| | characteristics | | |
| Number of days of the | | Acidity | |
| fermentation | pH | (g/L) | Organoleptic properties |
| Extract/Raw, | 6.04 | 0 | Dark orange color; bitter |
| unfermented product | | | and earthy taste |
| (prior to fermentation) | | | |
| 0 (Raw, unfermented | 4.94 | 0.4 | Orange color; bitter and |
| product) | | | earthy taste |
| 14 | 2.88 | 4.2 | Orange color; acid, bitter, |
| | | | and mild sweet-aromatic |
| | | | taste |
| 28 | 2.78 | 11.5 | Yellow color; acid, |
| | | | slightly sweet, bitter, |
| | | | and earthy taste; aromatic |
| | | | taste |
| 31 (fermented product) | 2.76 | 12.6 | Yellow color; acid and |
| | | | aromatic taste; no bitter |
| | | | and earthy taste |

As indicated in Table 3, the profile of the components of the product changed during fermentation over time. Brix values decreased, likely indicating the first step of bioconversion by yeasts action. At the same time, pH decreased indicating the increase of the acidity level in the medium, likely caused by bacterial action. Through the two steps of bioconversion, organoleptic properties of fermented product are improved.

The products obtained prior to, during and after fermentation were analyzed by HPLC analyses using a 1260 Infinity (Agilent Technology), including a quaternary pump, a temperature-controlled column compartment, an auto sampler and, a UV absorbance detector. Acetonitrile in water were used for elution in analyses.

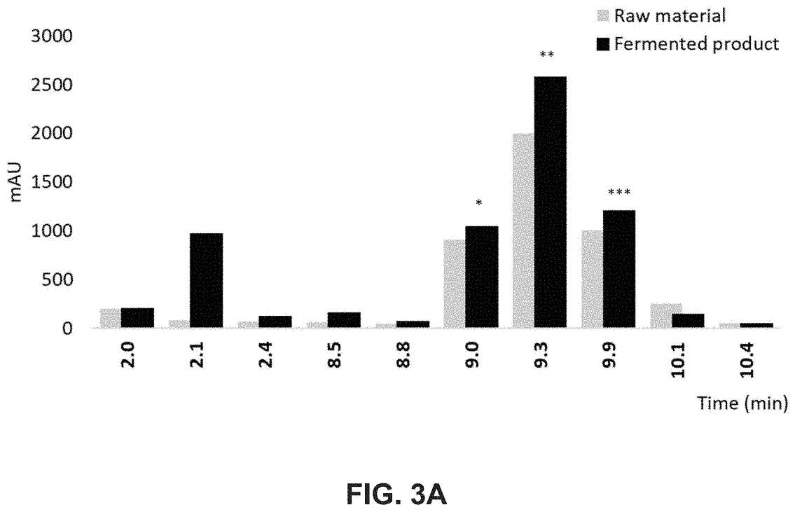

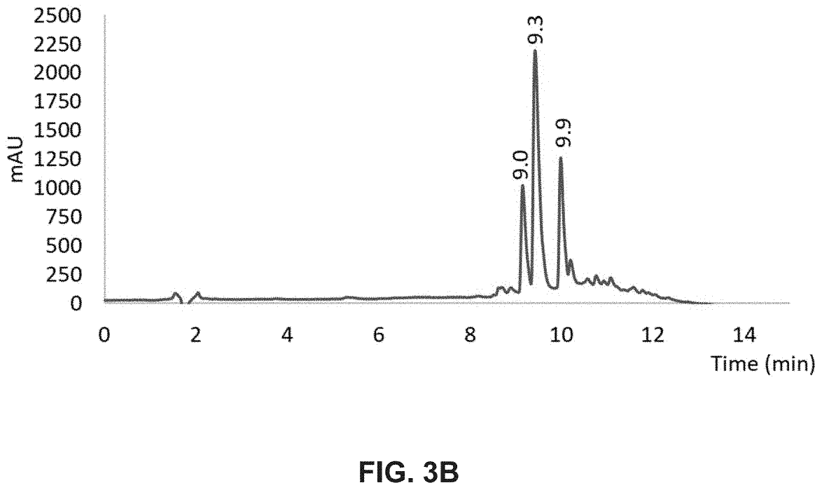

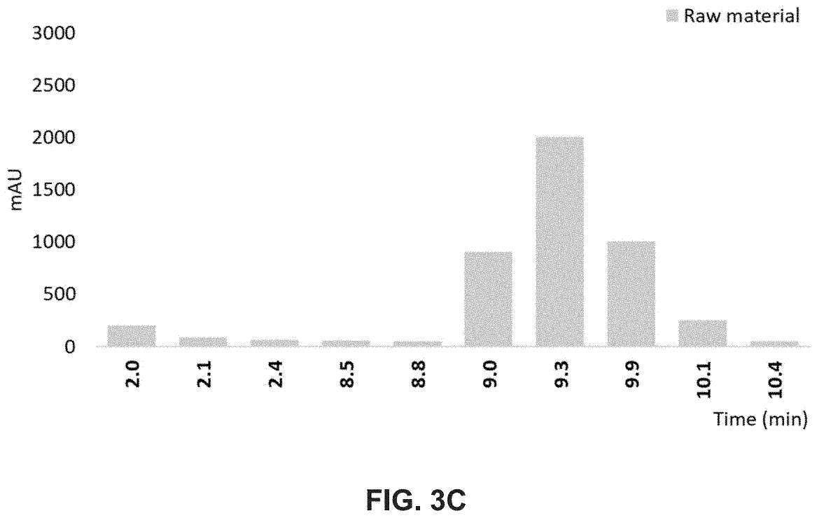

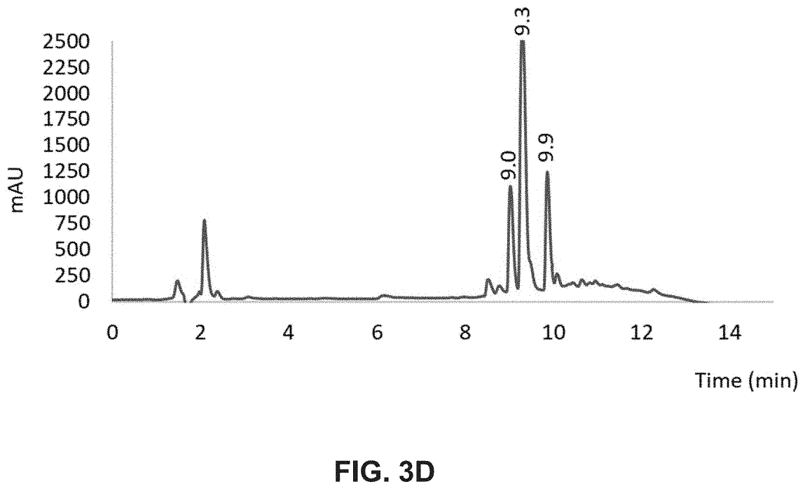

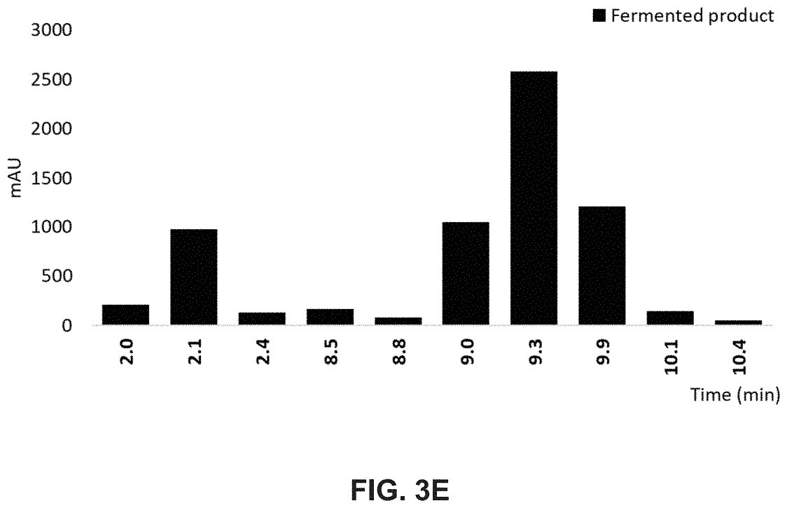

As shown in FIG. 3, HPLC results showed several peaks for guarana raw material (represented by grey bars) which changed in intensity and nature over the fermentation. For example, the concentration of catechin (indicated by *; retention time of 9.0 min), the concentration of caffeine (indicated by **; retention time of 9.3 min), and epigallocatechin-3-gallate (indicated by ***; retention time of 9.9 min) increased by 14.6%, 28.5%, and 19.4%, respectively (see in FIG. 3A the changes prior (raw material) to and after (fermented product) fermentation).

While the invention has been described in connection with specific embodiments thereof, it will be understood that the scope of the claims should not be limited by the preferred embodiments set forth in the examples, but should be given the broadest interpretation consistent with the description as a whole.

What is claimed is:

1. A fermented plant composition comprising (i) at least one component of an aqueous extract of a plant and (ii) at least one organic acid of a fermentation of the aqueous extract of the plant by a consortium of a symbiotic culture of bacteria and yeasts, wherein the aqueous extract of the plant has an organoleptic defect prior to the fermentation.

2. The fermented plant composition of claim 1, wherein the organic acid comprises acetic acid, butyric acid, glucoronic acid, gluconic acid, citric acid, L-lactic acid, malic acid, tartaric acid, malonic acid, oxalic acid, succinic acid, pyruvic acid, mannonic acid, propionic acid, ascorbic acid and/or usnic acid.

3. The fermented plant composition of claim 1, wherein the plant is from Stevia sp.

4. The fermented plant composition of claim 3 comprising at least 15% more of rebaudioside A and/or at least 15% less of stevioside than the aqueous extract of the plant.

5. The fermented plant composition of claim 1, wherein the plant is from Siraitia sp.

6. The fermented plant composition of claim 5 comprising at least 15% more of at least one of mogroside IV or siaminoside-1 and/or at least 15% less of mogroside V than the aqueous extract of the plant.

7. The fermented plant composition of claim 1, wherein the plant is from Paullinia sp.

8. The fermented plant composition of claim 7 comprising at least 10% more caffeine than the aqueous extract of the plant.

9. The fermented plant composition of claim 1, wherein the plant is from Cannabis sp.

10. The fermented plant composition of claim 1 comprising one or more of the following fermentation products of the symbiotic consortium: alcohol, amino acids and/or biocides.

11. The fermented plant composition of claim 1 having an increased bioavailability, when compared to the aqueous plant extract, in at least one vitamin, mineral or antioxidant molecule.

12. The fermented plant composition of claim 1 being a liquid or a solid.

13. A process for obtaining a fermented plant composition, the process comprising:
(a) providing an aqueous extract from a plant;
(b) adding a carbohydrate source to the aqueous extract of the plant to obtain a supplemented aqueous plant extract; and
(c) fermenting the supplemented aqueous plant extract to with a consortium of a symbiotic culture of bacteria and yeasts under conditions to allow the production of an organic acid by the bacteria of the consortium in the fermented plant composition; and
wherein the aqueous extract of the plant has an organoleptic defect prior to fermentation, and
wherein the carbohydrate source can be metabolized by the yeasts of the consortium.

14. The process of claim 13, wherein the plant is from Stevia sp., Siraitia sp., Paullinia sp. or Cannabis sp.

15. The process of claim 13 further comprising, prior to step (a), performing an aqueous extraction of the plant.

16. The process of claim 13 further comprising, after step (c), removing or inactivating the consortium.

17. The process of claim 16 comprising filtering, sterilizing and/or pasteurizing the fermented plant composition.

18. The process of claim 13 maintaining the relative concentration of the components after step (c).

19. A beverage comprising the fermented plant composition of claim 1.

20. A food comprising the fermented plant composition of claim 1.
